(19) United States
(12) Patent Application Publication
(10) Pub. No.: US 2004/0113535 A1
(43) Pub. Date: Jun. 17, 2004

(54) Deflection system for colour cathode-ray tube with horizontal coma correction

(76) Inventors: Azzi Nacerdine, Fontaine-Les-Dijon (FR); Olivier Masson, Dijon (FR); Sebastien Volatier, Dijon (FR)

Correspondence Address: Joseph S Tripoli, Thomson Licensing Inc, Patent Operations CN 5312, Princeton, NJ, 08543-0028, US

(21) Appl. No.: 10/451,611

(22) PCT Filed: Dec. 18, 2001
(86) PCT No.: PCT/EP01/14930

(30) Foreign Application Priority Data
Dec. 22, 2000 (FR) 00/16840

(51) Int. Cl. H01J 29/70

(52) U.S. Cl. 313/440; 335/210

(57) ABSTRACT

Deflector for cathode-ray tube comprising a pair of horizontal deflection coils and a pair of vertical deflection coils, the two pairs being in the shape of a saddle and isolated one from the other by a separator, a frustoconical shaped ferrite ring at least partially covering the deflection coils, the deflector being characterized in that it includes to the rear of the deflection coils, between the horizontal and vertical deflection coils, four field shapers placed symmetrically with respect to the axes of symmetry of the deflector. These shapers are placed so as to increase the amplitude of the second harmonic of the potential of the vertical deflection field without affecting the fundamental of the said potential in order to act on the phenomena of coma appearing on the horizontal edges of the image formed on the tube screen.

The invention relates to a deflection unit for a colour cathode-ray tube, which unit is also called a deflector and comprises a pair of horizontal deflection coils and a pair of vertical deflection coils in the shape of a saddle and more particularly to a deflector including magnetic field shapers intended to improve landing errors on the tube screen of red/blue beams with respect to the green beam along the horizontal edges of the screen.

A cathode-ray tube intended to generate colour images generally comprises an electron gun emitting three coplanar electron beams, each beam being intended to excite a phosphor of a predetermined primary colour (red, green or blue) on the tube screen.

The electron beams scan the tube screen under the effect of the deflection fields created by the horizontal and vertical deflection coils of the deflector attached to the neck of the tube. A separator made of plastic isolates the two pairs of coils and provides the mechanical stiffness of the deflector. A ring made of ferromagnetic material surrounds the deflection coils in a conventional manner so as to concentrate the deflection fields in the appropriate region.

The three beams generated by the electron gun must always converge on the tube screen otherwise a so-called convergence error is introduced which falsifies, in particular, the colour rendition. In order to make the three coplanar beams converge, it is known to use so-called self-converging astigmatic deflection fields; in a self-converging deflection coil, the field intensity or the flux lines which are caused by the horizontal deflection winding are generally in the shape of a pincushion in the region of a portion of the coil which is located somewhat to the front of the latter on the tube screen side. This amounts to introducing, into the distribution of turns forming the line coil, a very positive third harmonic of the ampere-turns density in front of the coil.

Moreover, under the action of uniform horizontal and vertical magnetic deflection fields, the volume scanned by the electron beams is a pyramid whose apex is coincident with the centre of deflection of the deflector and whose intersection with a non-spherical screen surface exhibits a geometrical defect called pincushion distortion. This geometrical distortion of the image increases as the radius of curvature of the tube screen increases. The self-convergent deflectors generate astigmatic deflection fields making it possible to modify the North/South and East/West geometry of the image and, in particular, provide partial compensation for the North/South pincushion distortion.

The design of the deflector must also take into account coma which is an aberration which affects the side beams coming from an electron gun having three beams in line, independently of the astigmatism of the deflection fields and of the curvature of the screen surface of the tube; these side beams, intended to form the red and blue image, enter the deflection region at a small angle with respect to the tube axis and undergo a deflection in addition to that of the central beam, intended to form the green image. The coma is generally corrected by modifying the distribution of the deflection fields at the point where the beams enter the deflector so that the coma generated compensates for that produced by the field distribution necessary to obtain the desired astigmatism for self-convergence. Thus, with regard to the horizontal deflection field, the field at the rear of the deflector has the shape of a barrel and in the front part has the shape of a pincushion.

The current market for cathode-ray tubes requires tubes whose front face is increasingly flat. This requirement poses technical problems in the design of deflectors. Among these problems, one of them is connected to correcting the coma along the horizontal edges of the image, the horizontal lines formed by the red/blue beams being formed outside the frame formed by the horizontal green lines.

In the deflectors whose horizontal and vertical deflection coils are saddle-shaped, it is known that the coma is corrected by modifying the astigmatism to the rear of the deflection coils, in particular by modifying the winding in order to introduce an increase in the third harmonic of the magnetic scalar potential.

However, this type of modification introduces modifications of other parameters such as the beam convergence or the geometry of the image on the tube screen. This results in a situation where it is necessary to make compromises between the various design parameters of the deflector, without easily optimizing these various parameters.

The invention aims to provide a simple and inexpensive solution to this situation, a solution which makes it possible to improve the coma along the horizontal edges of the image without impairing the other parameters such as the beam convergence or the image geometry.

To do this, the deflector according to the invention comprises a pair of horizontal deflection coils and a pair of vertical deflection coils, the two pairs being in the shape of a saddle and isolated one from the other by a separator, the deflector being characterized in that it includes to the rear of the deflection coils, between the horizontal and vertical deflection coils, four field shapers placed symmetrically with respect to the axes of symmetry of the deflector.

The invention will be better understood using the description below and the drawings, among which:

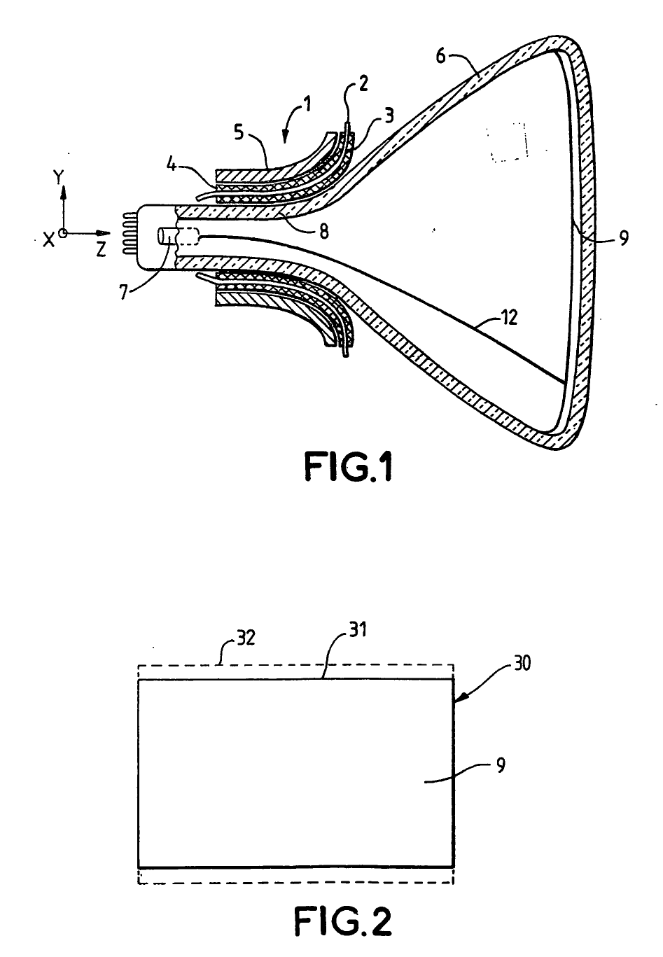

FIG. 1 shows, in section, a deflector according to the invention fitted to the neck of a cathode-ray tube.

FIG. 2 illustrates the aberration of coma along the horizontal edges of the image, which the invention aims to correct.

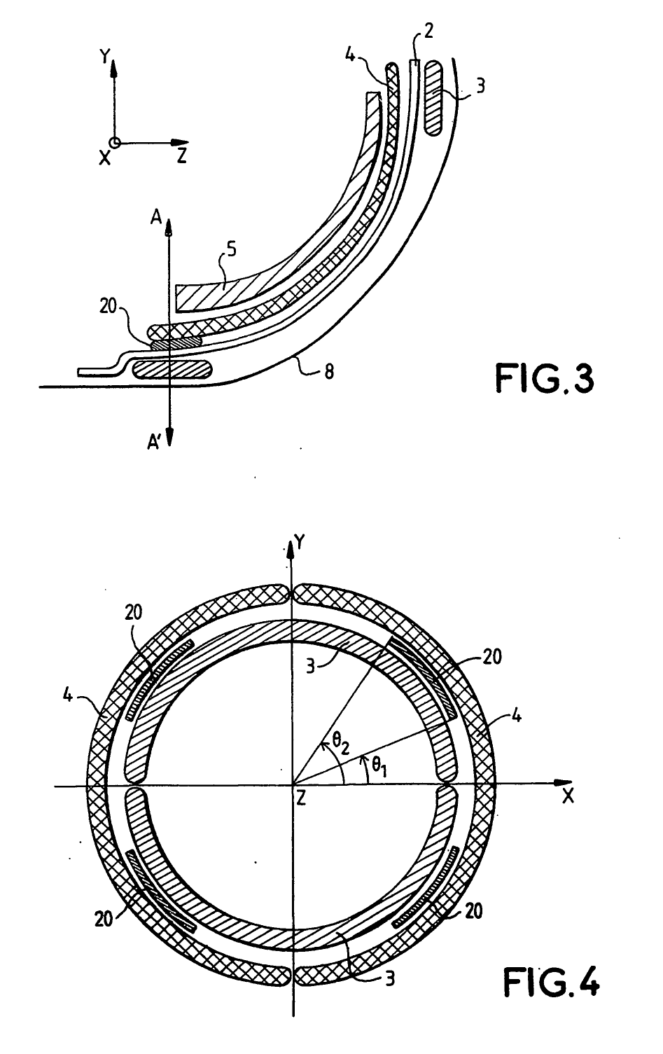

FIG. 3 shows, along a longitudinal section, the positioning of the field shapers according to the invention along the longitudinal axis Z.

FIG. 4 illustrates, by a facing view, the positioning of the field shapers in the deflector.

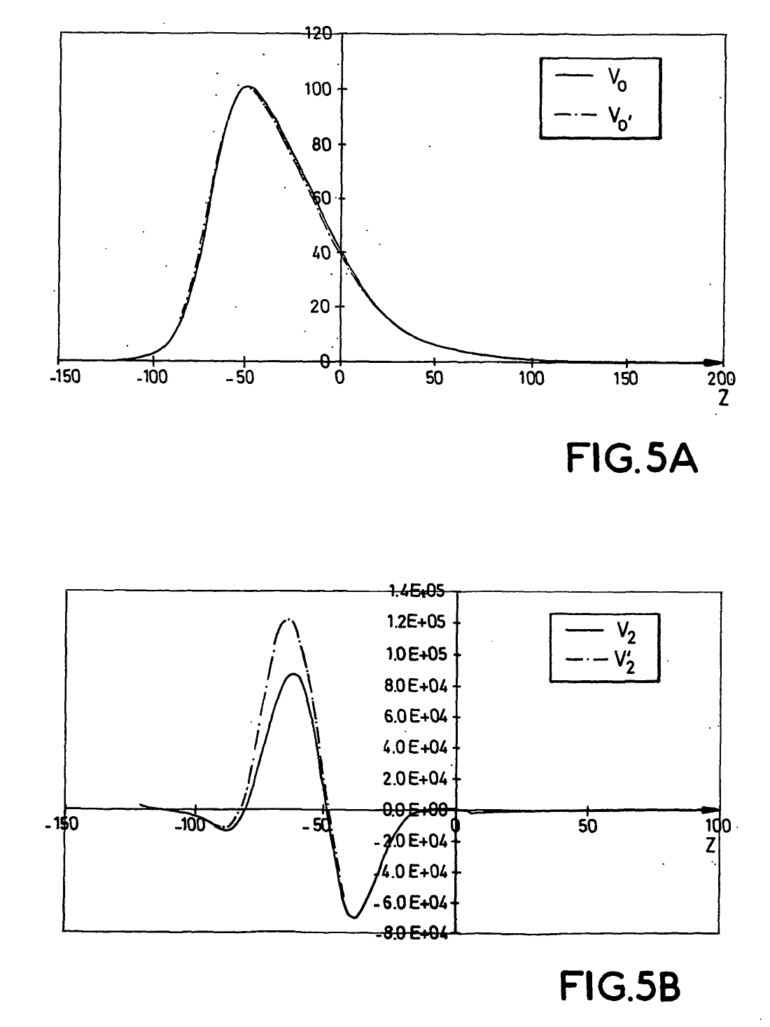

FIGS. 5A and 5B show the effect of the field shapers on the fundamental and the second harmonic of the vertical deflection field potential.

FIG. 1 shows, in section, a deflector 1 according to the invention, placed on the neck 8 of a cathode-ray tube 6. The deflector comprises a pair of vertical deflection coils 4, a pair of horizontal deflection coils 3, the two pairs being isolated one from the other by a separator 2 which is generally made of plastic and a ring 5 made of ferromagnetic material, intended to concentrate the magnetic fields created by the coils 3 and 4. These fields will deflect the electron beams 12 created by the electron gun 7 such that the said beams scan the screen 9 of the tube 6.

In FIG. 2, the defect of coma, which the invention aims to solve, is shown.

On the screen 9 of the tube, the image of a rectangle 30 closely following the edges of the said screen appears with an offset between the red/blue image 32 and the green image 31 of the horizontal edges, the green edges being inside the red/blue image, as a result generating a coma error which, by convention, has a negative value. The phenomenon is more sensitive the flatter the front face of the screen and more particularly so for the new-generation tubes having a completely flat front face.

It is known that the vertical deflection field, along the longitudinal axis Z can be represented by an even polynomial of the form:

V_{(y,z)}=V_{o(z)}+V_{2(z)*}Y²+V_{4(z)*}Y⁴+. . .

where V₀ is the fundamental of the vertical field and V₂ₙ the higher-ranking harmonics.

It has been noticed that by acting only on the rear of the vertical deflection field, it is possible to remedy the coma problem mentioned above. However, by acting only on the configuration of the conductors forming the deflection coils, it appears impossible to correct this defect without impairing the other parameters such as the beam convergence or even the geometry of the image formed on the tube screen.

Within the scope of the invention illustrated by FIGS. 3 and 4, field shapers 20 are placed under the vertical deflection coils 4 and above the horizontal deflection coils 3, this arrangement making it possible to act predominantly on the vertical deflection field without having a notable effect on the horizontal deflection field.

Preferably, the shapers 20 are placed on the separator 2, either on its internal surface or on its external surface. They are held by adhesive bonding on the separator and can be automatically positioned on the said separator by providing, for example, housings moulded on the surface to which they will be secured.

Since the purpose of the shapers is to act on the harmonics of the deflection field without significantly affecting the fundamental of the field, it has been chosen to provide four shapers 20 arranged symmetrically with respect to the X and Y axes of the deflector, the X axis forming, with the longitudinal Z axis, the plane separating the horizontal deflection coils 3, and the Y axis forming, with the Z axis, the plane separating the vertical deflection coils. This arrangement is illustrated in FIG. 4, which shows the perpendicular section through the longitudinal Z axis made in the rear part of the deflector through AA′ indicated in FIG. 3.

In one exemplary embodiment of the invention described below, the deflector intended for a tube with a flat front face of 16/9 format and with a diagonal of 76 cm, comprises four square-shaped shapers with 12 mm sides. The shapers are made from a material comprising an alloy, the majority of which is silicon, which has the best properties for a magnetic screen.

In order to obtain the best effect on the field harmonics and consequently in solving the coma phenomena described above, experiments have shown that the shapers should preferably be placed in a radial angular aperture of between θ1=30° and θ2=60°, θ1 and θ2 being measured from the plane separating the horizontal deflection coils; this means that at least half the surface of the shapers facing the vertical deflection coils is placed in this angular aperture. In this way, the effect on the field harmonics can be almost completely dissociated from the effect on the fundamental, as illustrated in FIGS. 5A and 5B. These two figures illustrate the embodiment in which the shapers are placed in the preferential angular aperture and in a position along the longitudinal Z axis such that the shapers are covered over two-thirds of their length along Z by the ferromagnetic ring 5. The position Z=0 corresponds to the support plane at the front of the deflector.

In FIG. 5A, it can be seen that the fundamental of the vertical field is not modified as a consequence by the shapers 20, the position and the amplitude of the fundamental V0 without the shaper being almost identical to the position and amplitude of the fundamental V0′ with the shapers 20.

In contrast, in FIG. 5B, the second rank harmonic is such that its amplitude V2′ is greatly increased by the shapers 20, compared with the amplitude V2 without a shaper, as is the action region of the field along the longitudinal Z axis.

Under the conditions described above, and compared to the starting situation without the shaper, the variations in distance between the horizontal edges of the red/blue image compared to the green image are expressed in millimetres in the following table, representing a quarter of the tube screen:

| | | | |
|---|---|---|---|
| 12H | | | 1H |
| 0.51 | 0.45 | 0.38 | |
| 0.25 | 0.23 | 0.17 | |
| Centre | | | 3H |

These results show that introducing the shapers has displaced the red/blue image in a direction tending to reduce the coma error, since the positive variation can be subtracted from the starting negative value to arrive at a value which is ideally zero, or which complies with a range of minimum values.

The preceding example is not limiting, it being possible for the coma amplitude to be corrected, the distribution of the correction between the middle of the horizontal edge (at 12H) and the corner of the image (at 1H) to be corrected by matching the surface of each shaper, its position along the longitudinal Z axis or its radial position in the 30°-60° window.

1. Deflector for cathode-ray tube comprising a pair of horizontal deflection coils (3) and a pair of vertical deflection coils (4), the two pairs being in the shape of a saddle and isolated one from the other by a separator (2), a frustoconical-shaped ferrite ring (5) at least partially covering the deflection coils, the deflector being characterized in that it includes to the rear of the deflection coils, between the horizontal and vertical deflection coils, four field shapers (20) placed symmetrically with respect to the horizontal X and vertical Y axes of symmetry of the deflector.

2. Deflector for cathode-ray tube comprising a pair of horizontal deflection coils (3) and a pair of vertical deflection coils (4), the two pairs being in the shape of a saddle and isolated one from the other by a separator (2), a frustoconical-shaped ferrite ring (5) at least partially covering the deflection coils, the deflector being characterized in that it includes to the rear of the deflection coils, between the horizontal and vertical deflection coils, field shapers placed so as to increase the amplitude of the second harmonic of the vertical deflection field without affecting the fundamental of the said field.

3. Deflector according to the preceding claim, characterized in that the field shapers are partly placed outside the ferrite ring.

4. Deflector according to one of the preceding claims, characterized in that the shapers lie, at least partially, in a radial angular aperture between 30° and 60° measured from the plane of separation of the horizontal deflection coils.

5. Deflector according to one of the preceding claims, characterized in that the field shapers are made from a material, the majority of which is silicon.

6. Cathode-ray tube comprising a deflector according to at least one of the preceding claims.

7. Cathode-ray tube according to the preceding claim, characterized in that the front face of the tube is substantially flat.
